(19) United States
(12) Patent Application Publication
(10) Pub. No.: US 2020/0175174 A1
(43) Pub. Date: Jun. 4, 2020

(54) Vulnerability Context Graph

(71) Applicant: SAP SE, Walldorf (DE)

(72) Inventors: Jamarber Bakalli, Cambridge, MA (US); Michele Bezzi, Le Haut Sartoux Valbonne (FR); Cedric Dangremont, Saint-Cezaire-Sur-Siagne (FR); Sule Kahraman, Cambridge, MA (US); Henrik Plate, Valbonne (FR); Serena Ponta, Antibes (FR); Antonino Sabetta, Mouans Sartoux (FR)

(21) Appl. No.: 16/209,826

(22) Filed: Dec. 4, 2018

(51) Int. Cl. G06F 21/57; G06F 8/71; G06N 5/02; G06F 16/901

(52) U.S. Cl. CPC G06F 21/577; G06F 8/71; G06F 2221/033; G06F 16/9024; G06N 5/02

(57) ABSTRACT

Data is received that characterizes source code requiring a security vulnerability assessment. Using this received data, an input node of a vulnerability context graph is generated. Subsequently, at least one node is resolved from the input node using at least one of a plurality of resolvers that collectively access each of a knowledge base, a source code commit database, and at least one online resource. Additionally nodes are later iteratively resolved at different depth levels until a pre-defined threshold is met. The vulnerability context graph is then caused to be displayed in a graphical user interface such that each node has a corresponding graphical user interface element which, when activated, causes complementary information for such node to be displayed.

### TECHNICAL FIELD

The subject matter described herein relates to the generation and visualization of a vulnerability context graph characterizing security-related vulnerabilities in a code base.

### BACKGROUND

Software vulnerabilities are typically announced through advisories, which usually consist of short, high-level, textual descriptions in natural language. These advisories are published through various channels, such as project web pages, newsletters, and government-run archives, such as the National Vulnerability Database (NVD). All these sources, and in particular the NVD, are known to suffer from poor coverage and inconsistent quality. On the other hand, vulnerabilities are often discussed in details in bug tracking systems, and fixed by performing code changes in software code repositories. Reconciling the high-level description of vulnerabilities with the code level details discussed and applied to patch it is required for enabling a reliable identification and assessment of the vulnerabilities.

### SUMMARY

In a first aspect, data is received that characterizes source code requiring a security vulnerability assessment. Using this received data, an input node of a vulnerability context graph is generated. Subsequently, at least one node is resolved from the input node using at least one of a plurality of resolvers that collectively access each of a knowledge base, a source code commit database, and at least one online resource. Additionally nodes are later iteratively resolved at different depth levels until a pre-defined threshold is met. The vulnerability context graph is then caused to be displayed in a graphical user interface such that each node has a corresponding graphical user interface element which, when activated, causes complementary information for such node to be displayed.

The at least one online resource can be an online vulnerability advisory.

Different types of resolvers can be used to generate nodes at different levels of the vulnerability context graph.

The vulnerability context graph can include different types of nodes such as: a commit node representing a specific source code commit in a source code repository, a bug-tracking node representing bug-tracking tickets issued by a bug-tracking system, a Common Vulnerabilities and Exposures (CVE) entry in an online resource or database, and/or an unknown node that does not fit within one of a pre-defined plurality of node types.

In another interrelated aspect, data is received that characterizes a known security vulnerability. Based on this received data, an input node of a vulnerability context graph is generated. Thereafter, at least one node is resolved from the input node using at least one of a plurality of resolvers that collectively access at least one resource. Additional nodes are iteratively resolved at different depth levels until a pre-defined threshold is met. The vulnerability context graph is then caused to be displayed in a graphical user interface such that each node has a corresponding graphical user interface element which, when activated, causes complementary information for such node to be displayed.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides enhanced information and visualizations characterizing vulnerabilities of code bases. Further, such information collection and visualization consumes fewer processing resources (e.g., memory, processor resources, etc.) as compared to conventional techniques and, additionally, reduces the likelihood of vulnerabilities within deployed software.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a component diagram illustrating a computing environment for generating a vulnerability context graph;

FIG. 2 is a data model diagram;

FIG. 3 is a diagram illustrating an example vulnerability context graph;

FIG. 4 is a diagram illustrating a graphical user interface in which a vulnerability context graph is displayed in a first window and information complementary to a selected node in the vulnerability context graph is displayed in a second window;

FIG. 5 is a first process flow diagram illustrating generation of a vulnerability context graph;

FIG. 6 is a first process flow diagram illustrating generation of a vulnerability context graph; and

FIG. 7 is a diagram illustrating aspects of a computing device for implementing subject matter described herein.

### DETAILED DESCRIPTION

The subject matter provided herein provides for the reconstruction of a context graph of interconnected resources (advisories, mailing list archives, blog posts, bug tracking tickets, pull requests) that relate to a security vulnerability and its fix (source code commits). Starting from a resource, such as a CVE (Common Vulnerabilities and Exposures) entry, a commit in a source code repository, an advisory page, a bug-tracking ticket, a pull-request, or a mailing-list thread, applicable online resources (e.g., web pages) are crawled to obtain a graph of relevant resources (i.e. the vulnerability context), while also referencing pre-computed information to further expand the graph of resources. A visual representation of the vulnerability context graph in a graphical user interface allows for close and convenient inspection of individual resources and their attributes.

Advisories with vulnerability descriptions (e.g. CVE entries) are often published after a security fix is created for the affected software. Security fixes boil down to changes in the source code of the project developing the affected software. To better characterize the vulnerability, it is crucial to gather all existing information, including the commits that applied these changes to the source code. However, such security fixes are not often referenced from the advisory and it is error-prone and time consuming to identify them simply by manual inspection of the advisory pages and/or browsing the web. There is often little information, and no clear indication of which commit corresponds to the ticket.

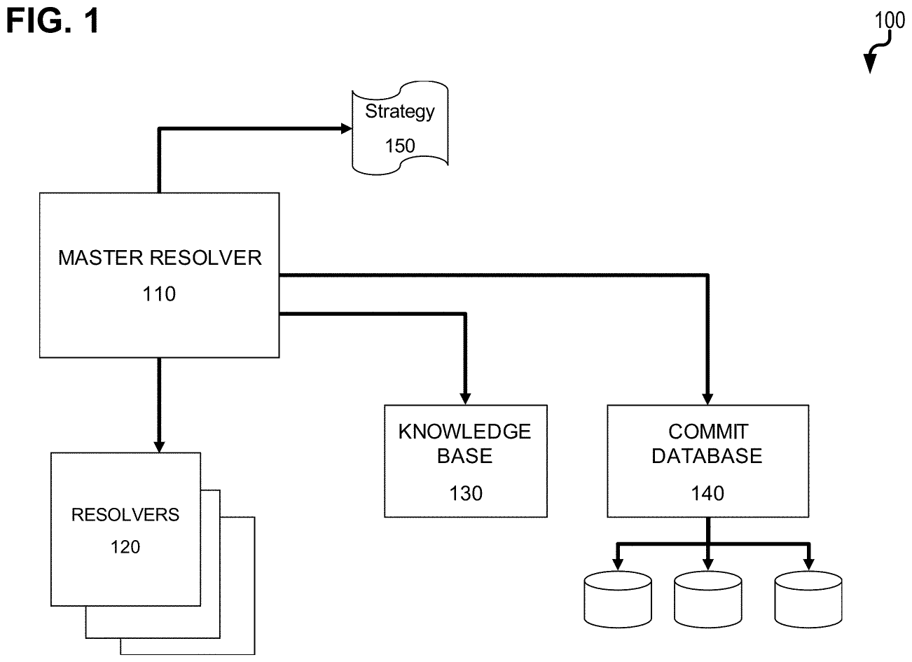

FIG. 1 is a diagram 100 showing various components to generate a vulnerability context graph as provided herein. Each of the components can comprise software modules executed by one more computing devices (each having at least one data processor and memory storing instructions for execution by the corresponding data processor(s)). A master resolver 110 is a main component that manages all of plurality of resolvers 120 which collectively can be used to generate a vulnerability context graph (as further described below). Given a web resource (i.e., a resource available online via a web site with or without user authentication), each resolver 120 can identify connected web resources by using a certain approach (for example, in the simplest case, following hyperlinks). The master resolver can be configured through a strategy 150, that can be defined by the user that describes which resolvers 120 should be used, and in what order. The strategy 150 can define that certain resolvers should only be used when resolving nodes of a certain depth from the starting node. Additionally, depending on the depth of the current node and on the attributes of the current node and of the other nodes resolved up to a given point, the strategy 150 can determine which parameter settings should be used for which resolver, thus adapting their behavior to the type and content of the nodes that have been discovered up to that point. Two additional components can be used by the resolvers 110, 120 to create the context graph, namely the knowledge base 130, and the commit database 140. The knowledge base 130 can provide metadata about open source software (OSS projects), a repository URL, or tags used in bug-tracking systems. The commit database 140 can contain a mapping of identifiers to commits (i.e., the latest change of software being developed, etc.) for each project in the knowledge base 130. The commit database 140 can be created by indexing versioning control systems (VCS) (e.g., fetching the source code repository of a project), obtaining the commit history of all branches of the repository, and then processing each commit to create a mapping from commit hash identifiers to modified filenames. Additional metadata may be included such as commits authors, associated timestamps, and the like.

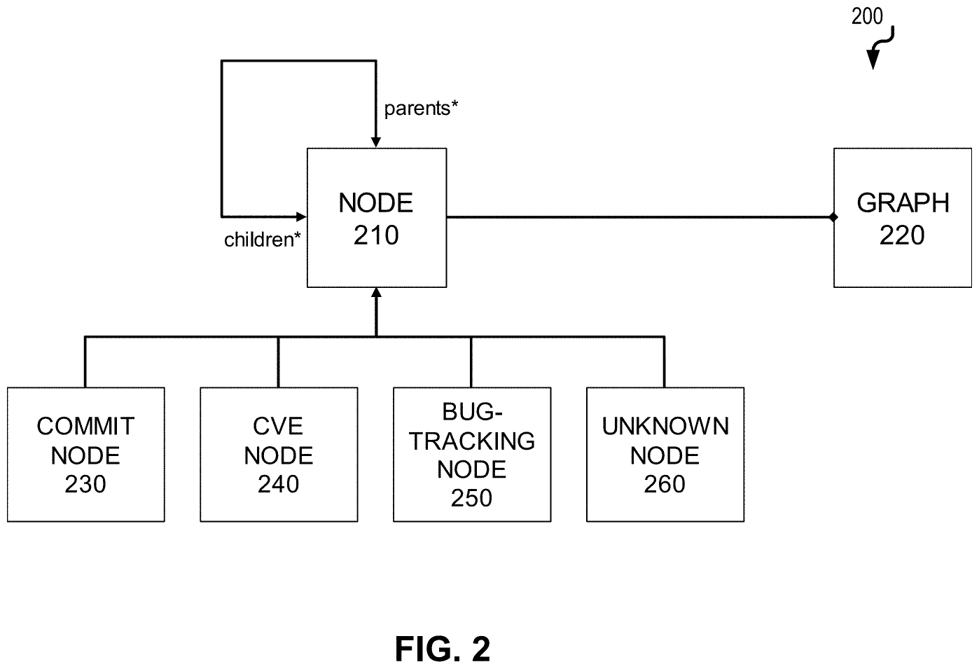

FIG. 2 is a diagram 200 illustrating a sample data model utilized by the current solution that comprises two objects: node 210 and graph 220. The vulnerability context graph can be represented as an object graph 220 which is an aggregation of nodes 210. Node objects can have pointers to their parent and child node objects. There can be four types of nodes: commit nodes 230, bug-tracking nodes 240, CVE nodes 250, and unknown type of nodes 260. Commit nodes 230 represent specific commits in the repository. Bug-tracking nodes 240 represent bug-tracking tickets (e.g., tickets in a Jira bug-tracking or other bug-tracking system, etc.). CVE nodes 250 represent CVE entries in the National Vulnerability Database. Unknown type of nodes 260 represent all kinds of pages that are neither a commit, bug-tracking ticket, nor a CVE entry.

When resolvers 120 are applied to an input node 210, they can act to expand the graph and create new nodes. The knowledge base 130 can support this process with pre-stored information useful to the resolvers 120. For example, the knowledge base 130 can contains a record for each open-source project of interest. As an example, each record can include at least the following information: name of the project, URL of its source code repository, URL of its bug tracking system(s), URL of its mailing list archives, list of alternative names of the project, list of terms associated to the project, list of abbreviations for the project. The commit database 140 can either access stored records of VCS repositories that have already been stored, or it can index new repositories depending on the instruction of the master resolver 110.

As noted above, there can be different types of resolvers 120. One example is a hyperlink resolver 120 that can fetch all of the <a> tags contained within the HTML code of the page corresponding to the input node and uses those tags to obtain all hyperlinks existing on that page. Such hyperlink resolver 120 can then follow those hyperlinks to fetch new pages, and thus resolve new nodes 210 that are added to the graph 220. Decisions on which hyperlinks to follow and which to ignore are taken based on the configuration of the strategy 150. In particular, certain URLs patterns can be blacklisted by the strategy 150, in which case, nodes matching those patterns would be ignored.

Another type of resolver 120 can be a bug tracking resolver 120 which is a semantic resolver. The bug tracking resolver 120 can depend on information it finds nested in the HTML of the node to which it is currently being applied. Through the use of regular expressions, this bug tracking resolver 120 can parse all tokens that match the structure of bug tracking ticket reference numbers, and then uses those tokens to construct URLs corresponding to those reference numbers. This construction of URLs can be supported by the knowledge base 130. It is common for open-source projects to use predefined abbreviations for the project name as prefixes of bug identifiers. For example, the Apache ActiveMQ project, denotes its bugs with identifiers such as ‘AMQ-nnnn’ (where nnnn is a 4 to 6 digit number). The bug tracking resolver 120 can concatenate these identifiers to a project-specific URL prefix, to obtain the exact URL of a given bug, thus resolving new nodes that are added to the vulnerability context graph 220. To do so, the bug tracking resolver 120 can use the knowledge base 130 to determine both the URL prefix of the bug tracking system as well as the bug identifier prefix (‘AMQ-’ in the example above) for the project of the input node.

A CVE resolver 120 can works similarly to the bug tracking resolver 120. The CVE resolver 120 can parse through the HTML of the node that it is currently being applied to, and it can use regular expressions to extract CVE identifiers, corresponding to vulnerability advisories in the NVD database or other similar type data source. The CVE resolver 120 can then use these CVE identifier to construct URLs corresponding to web pages in the NVD (while referencing the knowledge base 130 for additional information), and then uses these URLs to create new nodes 210 and add such nodes to the graph 220.

A commit resolver 120 can parse through the HTML code of the node 210 that it is currently being applied to, and it can use regular expressions to extract commit codes, corresponding to commits in VCS repositories. These commit codes can then be used to construct URLs corresponding to web pages in the VCS repository (e.g., GitHub). In addition, the knowledge base 130 can be used to get additional information. The resulting URLs can be used to create new nodes 210 which are added to the graph 220.

A search engine resolver 120 can parse the HTML code of a node 210 and uses regular expressions to obtain a bug tracking ticket identifier which, in turn, can be used to perform a web search together with the name of the repository corresponding to the open source project in question. The search engine resolver 120 can then look at the top results (e.g., top four results, etc.) and use the corresponding URLs to create new nodes 210 in the graph 22. This search engine resolver 120 can be applied only once, to the starting node 210 of the graph 220, due to the fact that it is very general and it should be avoided to include loosely related nodes at further depths.

A mail archives resolver 120 can work similarly to the search engine resolver 120, in that it also uses web searches, and can be used only once at the root node 210 of the graph 220. The mail archives resolver 120 can also behave differently (employs a different strategy) depending on the starting point of the graph 220. If the starting point is a VCS commit, the mail archives resolver 120 can use the bug tracking identifier discovered first in the HTML page and can search for the identifier along with the tag “site:” and the corresponding mailing archives site for the project in question. This arrangement effectively searches for the bug tracking identifier within these mailing archives, thus producing a fairly specific set of URLs, which are then used to create new nodes 210 in the graph 220. If the starting point is a CVE, this mail archives resolver 120 can search for the CVE entry in the mailing archives, instead of the bug tracking identifier.

A search CVE resolver 120 can parse the HTML of the node 210 for a CVE identifier and can searches that CVE identifier in both search sites for VCS repositories (if any) and the bug tracking search sites. The result are web pages from VCS repositories and bug tracking systems that reference the CVE identifier. New nodes 210 are created from these discovered URLs and added to the graph 220.

An identifier resolver 120 can obtain relevant identifier tokens (e.g. referencing variable names, class names, filenames) on the web page that is currently being examined, through the use of regular expressions (similarly to the bug tracking and CVE resolvers 120). The identifier resolver 120 can then search for those tokens in the VCS repositories search sites. The identifier resolver 120 can do this by obtaining from the knowledge base 130 the URL of the source code repository corresponding to the project of the input node and search the discovered tokens in that repository. The identifier resolver 120 can then scan the sites representing the search queries for relevant URLs, usually representing different commits in the VCS repository. For the sake of efficiency, an index of the content of the VCS can be precomputed, associating each token present in the history of the VCS to the list of commits where those tokens are mentioned (that is, the commits that add, remove or modify lines where those tokens appear).

An index resolver 120 can be configured such that it does not utilize web crawling to produce its output, but rather uses the commit database 140 of precomputed information about commits for OSS projects (including commit identifier, timestamps, etc.). This index resolver 120 can obtain relevant tokens (e.g. referencing variable names, class names, filenames) from the web page that is currently being examined. Then, the index resolver 120 can query for those tokens on the commit database 140, and can use the resulting commit identifiers to construct the URLs that correspond to those commits within VCS repositories. The index resolver 120 can then resolves new nodes 210 from these URLs. The index resolver 120 can also be customizable by inclusion of a temporal aspect—the user can specify either a time frame of dates, or a time frame of commits, so that the query only returns commit codes within the specified time frame.

A breadth-first search algorithm can be used to dynamically construct the context graph 220. Algorithm 1 below illustrates the pseudo-code for constructing a context graph of depth limited by a given threshold. The main loop implements two queue data structures, current_n and resolved_n. current_n initially contains only the starting node, and the resolved_n is initially empty. The algorithm then resolves all possible nodes from the first queue and adds the output to the second queue. This arrangements allows for traversal through all nodes of depth k before starting to resolve nodes of depth k+1. Once all possible nodes have been resolve, the first queue can be overwritten with the second queue, and the second queue can be emptied so level k+2 from k+1 can be resolved.

Algorithm 1 Main Loop

| | |
|---|---|
| 1: | graph ← ∅ |
| 2: | depth ← 0 |
| 3: | while depth <= threshold do |

| | |
|---|---|
| 4: | if current_n ≠ ∅ then |

| | |
|---|---|
| 5: | resolvers = strategy.getResolvers( ) |
| 6: | for n ∈ current_n do |

| | |
|---|---|
| 7: | for r ∈ resolvers do resolved_n ← resolved_n ∪ |
| | r.resolve(n) |

| | |
|---|---|
| 8: | graph ← graph ∪ current_n |
| 9: | current_n ← resolved_n |
| 10: | resolved_n ← ∅ |
| 11: | depth ← depth + 1 |

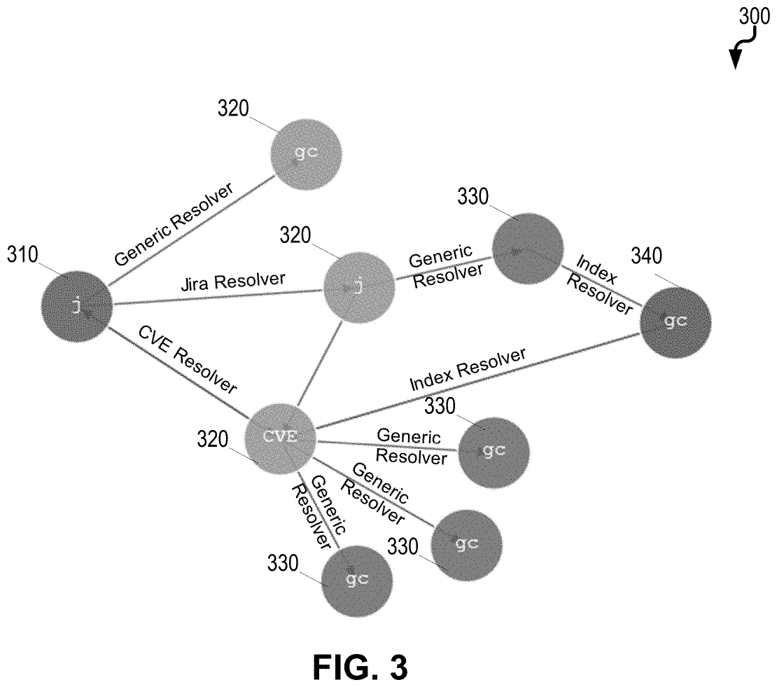

FIG. 3 is a diagram 300 illustrating an example context graph. In this graph, the root 310 of the graph can be a bug-tracking (e.g., Jira, etc.) node. The next layer of nodes 320 are resolved from the root node 310. For example, the node 310 labeled as ‘gc’ is a commit node and can be found through the hyperlink resolver. The bug tracking and CVE resolvers discovered the other nodes 310 at depth one level. The hyperlink resolver often discovers the majority of the nodes, as is apparent from the graph (particularly the nodes 330 at depth two level and the node 340 at depth three level).

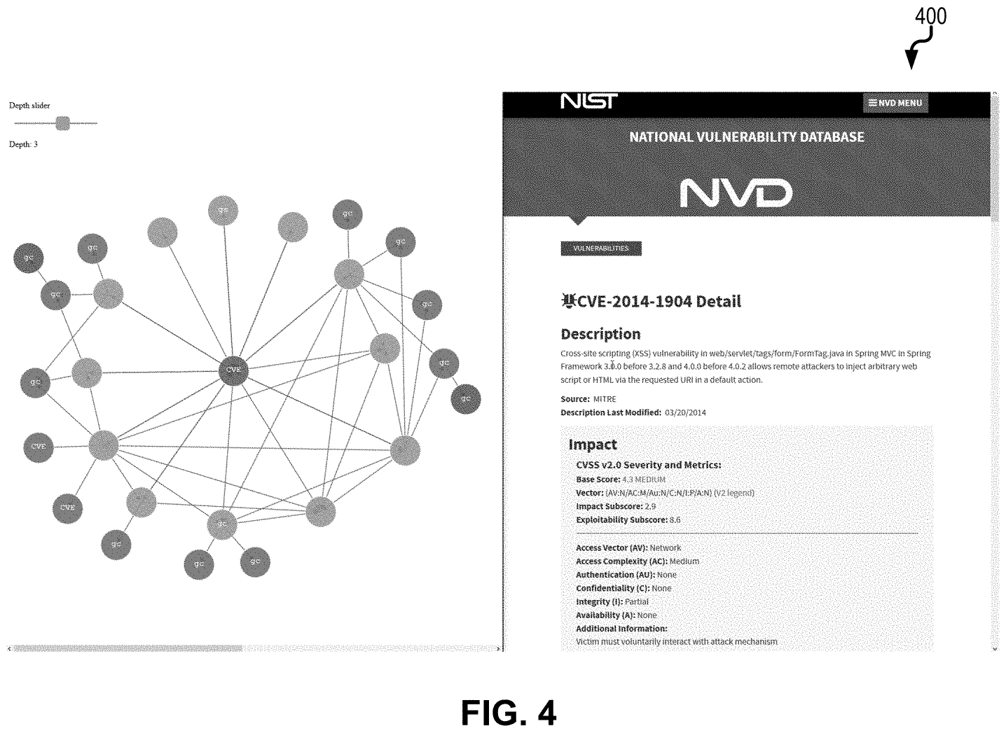

FIG. 4 is a diagram 400 illustrating a graphical user interface including, for example, a first window 410 illustrating a vulnerability context graph including a plurality of nodes and a second window 420 illustrating complementary information about one of the nodes. For example, each node in the first window 410 can have a corresponding graphical user interface element which, when activated via the graphical user interface, causes corresponding complementary information to be displayed in the second window 420.

With reference to both FIG. 3 and FIG. 4, the circles in the vulnerability context graphs are the node objects that represent a resource and the links between the circles represent directed edges. An edge pointing from one node to another means that the latter resource was discovered from the source resource. The nodes can have different visual representations (e.g., colors, etc.) according to their distance from the root (i.e., start node, etc.). Nodes can be labeled according to the type of the resource they represent. The user can, in some variations, also change the view of the graph by dragging nodes to different positions and/or by using a depth slider. The depth slider can enable the user to choose which nodes to view up to a certain depth. Double clicking or otherwise activating a node can open the second window 420 with the content (i.e. complementary information) of the resource that the node represents.

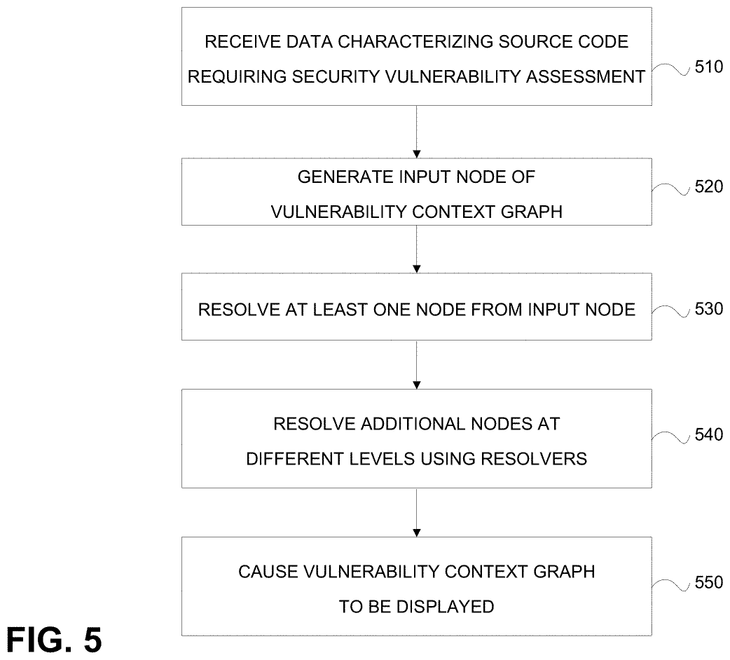

FIG. 5 is a process flow diagram 510 in which, at 510, data is received that characterizes source code requiring a security vulnerability assessment. Using this received data, at 520, an input node of a vulnerability context graph is generated. Subsequently, at 530, at least one node is resolved from the input node using at least one of a plurality of resolvers that collectively access each of a knowledge base, a source code commit database, and at least one online resource. Additionally, at 540, nodes are later iteratively resolved at different depth levels until a pre-defined threshold is met. The vulnerability context graph is then caused, at 550, to be displayed in a graphical user interface such that each node has a corresponding graphical user interface element which, when activated, causes complementary information for such node to be displayed.

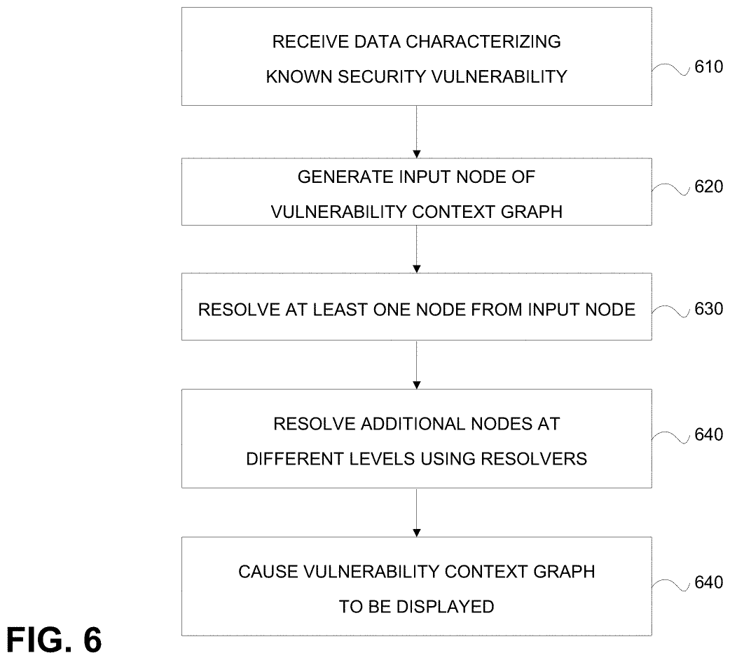

FIG. 6 is a process flow diagram 600 in which, at 610, data is received that characterizes a known security vulnerability. Based on this received data, at 620, an input node of a vulnerability context graph is generated. Thereafter, at 630, at least one node is resolved from the input node using at least one of a plurality of resolvers that collectively access at least one resource. Later, at 640, additional nodes are iteratively resolved at different depth levels until a pre-defined threshold is met. The vulnerability context graph is then caused, at 650, to be displayed in a graphical user interface such that each node has a corresponding graphical user interface element which, when activated, causes complementary information for such node to be displayed.

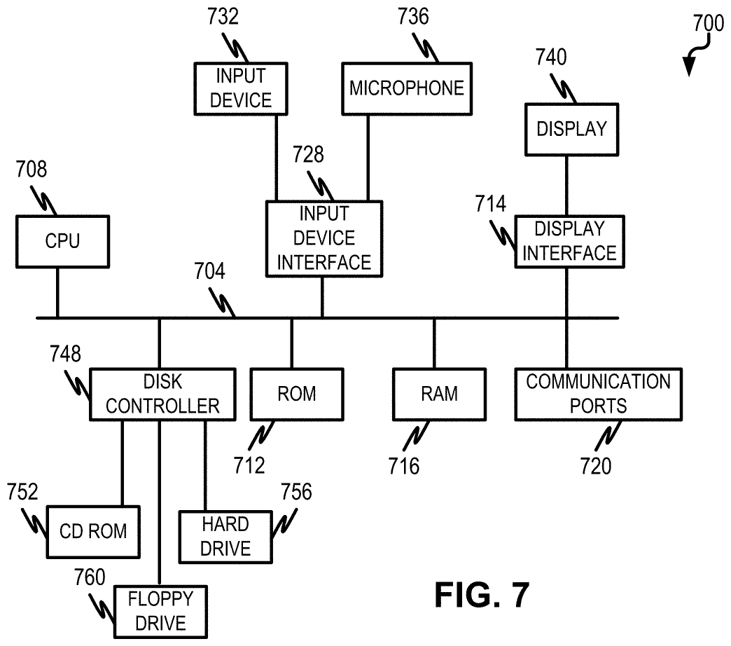

FIG. 7 is a diagram 700 illustrating a sample computing device architecture for implementing various aspects described herein. A bus 704 can serve as the information highway interconnecting the other illustrated components of the hardware. A processing system 708 labeled CPU (central processing unit) (e.g., one or more computer processors/data processors at a given computer or at multiple computers), can perform calculations and logic operations required to execute a program. A non-transitory processor-readable storage medium, such as read only memory (ROM) 712 and random access memory (RAM) 716, can be in communication with the processing system 708 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 748 can interface with one or more optional disk drives to the system bus 704. These disk drives can be external or internal floppy disk drives such as 760, external or internal CD-ROM, CD-R, CD-RW or DVD, or solid state drives such as 752, or external or internal hard drives 756. As indicated previously, these various disk drives 752, 756, 760 and disk controllers are optional devices. The system bus 704 can also include at least one communication port 720 to allow for communication with external devices either physically connected to the computing system or available externally through a wired or wireless network. In some cases, the communication port 720 includes or otherwise comprises a network interface.

To provide for interaction with a user, the subject matter described herein can be implemented on a computing device having a display device 740 (e.g., a CRT (cathode ray tube) or LCD (liquid crystal display) monitor) for displaying information obtained from the bus 704 via a display interface 714 to the user and an input device 732 such as keyboard and/or a pointing device (e.g., a mouse or a trackball) and/or a touchscreen by which the user can provide input to the computer. Other kinds of input devices 732 can be used to provide for interaction with a user as well; for example, feedback provided to the user can be any form of sensory feedback (e.g., visual feedback, auditory feedback by way of a microphone 736, or tactile feedback); and input from the user can be received in any form, including acoustic, speech, or tactile input. The input device 732 and the microphone 736 can be coupled to and convey information via the bus 704 by way of an input device interface 728. Other computing devices, such as dedicated servers, can omit one or more of the display 740 and display interface 714, the input device 732, the microphone 736, and input device interface 728.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) and/or a touch screen by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving data characterizing source code requiring a security vulnerability assessment;
generating, based on the received data, an input node of a vulnerability context graph;
resolving at least one node from the input node using at least one of a plurality of resolvers, the resolvers collectively accessing each of a knowledge base, a source code commit database, and at least one online resource;
iteratively resolving additional nodes at different depth levels until a pre-defined threshold is met; and
causing the vulnerability context graph to be displayed in a graphical user interface such that each node has a corresponding graphical user interface element which, when activated, causes complementary information for such node to be displayed.

2. The method of claim 1, wherein the at least one online resource comprises an online vulnerability advisory.

3. The method of claim 1, wherein different types of resolvers are utilized to generate nodes at different levels of the vulnerability context graph.

4. The method of claim 1, wherein the nodes include at least one commit node representing a specific source code commit in a source code repository.

5. The method of claim 1, wherein the nodes include at least one bug-tracking node representing bug-tracking tickets issued by a bug-tracking system.

6. The method of claim 1, wherein the nodes include at least one Common Vulnerabilities and Exposures (CVE) entry in an online resource or database.

7. The method of claim 1, wherein the nodes include at least one unknown node that does not fit within one of a pre-defined plurality of node types.

8. A computer-implemented method comprising:
receiving data characterizing a known security vulnerability;
generating, based on the received data, an input node of a vulnerability context graph;
resolving at least one node from the input node using at least one of a plurality of resolvers, the resolvers collectively accessing at least one resource;
iteratively resolving additional nodes at different depth levels until a pre-defined threshold is met; and
causing the vulnerability context graph to be displayed in a graphical user interface such that each node has a corresponding graphical user interface element which, when activated, causes complementary information for such node to be displayed.

9. The method of claim 8, wherein the at least one resource is an online resource.

10. The method of claim 9, wherein the online resource comprises an online vulnerability advisory.

11. The method of claim 8, wherein the at least one resource comprises source code commits.

12. The method of claim 8, wherein different types of resolvers are utilized to generate nodes at different levels of the vulnerability context graph.

13. The method of claim 8, wherein the nodes include at least one commit node representing a specific source code commit in a source code repository.

14. The method of claim 8, wherein the nodes include at least one bug-tracking node representing bug-tracking tickets issued by a bug-tracking system.

15. The method of claim 8, wherein the nodes include at least one Common Vulnerabilities and Exposures (CVE) entry in an online resource or database.

16. The method of claim 8, wherein the nodes include at least one unknown node that does not fit within one of a pre-defined plurality of node types.

17. A system comprising:
at least one data processor; and
memory storing instructions which, when executed by the at least one data processor, result in operations comprising:
receiving data characterizing source code requiring a security vulnerability assessment;
generating, based on the received data, an input node of a vulnerability context graph;
resolving at least one node from the input node using at least one of a plurality of resolvers, the resolvers collectively accessing each of a knowledge base, a source code commit database, and at least one online resource;
iteratively resolving additional nodes at different depth levels until a pre-defined threshold is met; and
causing the vulnerability context graph to be displayed in a graphical user interface such that each node has a corresponding graphical user interface element which, when activated, causes complementary information for such node to be displayed.

18. The system of claim 17, wherein the at least one online resource comprises an online vulnerability advisory.

19. The system of claim 18, wherein different types of resolvers are utilized to generate nodes at different levels of the vulnerability context graph; and
wherein the nodes include:
at least one commit node representing a specific source code commit in a source code repository;
at least one bug-tracking node representing bug-tracking tickets issued by a bug-tracking system; and
at least one Common Vulnerabilities and Exposures (CVE) entry in an online resource or database.

20. The system of claim 19, wherein the nodes include at least one unknown node that does not fit within one of a pre-defined plurality of node types.
